(19) United States
(12) Patent Application Publication
(10) Pub. No.: US 2018/0267320 A1
(43) Pub. Date: Sep. 20, 2018

(54) HEAD-MOUNTED DISPLAY APPARATUS AND ADJUSTING METHOD THEREOF

(71) Applicant: Quanta Computer Inc., Taoyuan City (TW)

(72) Inventors: Chun-Lung CHEN, Taoyuan City (TW); Cho-Lin HUANG, Taoyuan City (TW); Chun-Yun TSENG, Taoyuan City (TW)

(21) Appl. No.: 15/675,943

(22) Filed: Aug. 14, 2017

(30) Foreign Application Priority Data
Mar. 16, 2017 (TW) 106108669

(51) Int. Cl. G02B 27/01

(52) U.S. Cl. CPC G02B 27/0176; G02B 2027/0132; G02B 27/0172

(57) ABSTRACT

A head-mounted display apparatus includes a housing, a display panel, a lens base, an adjusting ring, and a lens. The display panel is disposed in the housing. The lens base is disposed on the display panel, and includes a first guiding element. The adjusting ring is disposed on the lens base, and includes a second guiding element attached to the first guiding element. The lens is disposed on the adjusting ring. The first guiding element and the second guiding element extend along a spiral path.

### CROSS-REFERENCE TO RELATED APPLICATIONS

This Application claims priority of Taiwan Patent Application No. 106108669 filed on Mar. 16, 2017, the entirety of which is incorporated by reference herein.

### BACKGROUND OF THE INVENTION

### Field of the Invention

The present disclosure relates to a display apparatus, and in particular to a head-mounted display apparatus.

### Description of the Related Art

A conventional virtual reality apparatus is configured to be worn on the user's head, and to provide 3D images to the user. The conventional virtual reality apparatus includes a display panel, and two lenses that correspond to the user's two eyes. The display panel is configured to display a left-eye image and a right-eye image, respectively entering through the left eye and the right eye via the lenses, and a 3D image is presented by the left-eye image and the right-eye image.

However, during the manufacturing process of the virtual reality apparatus, the positions of the left-eye image and the right-eye image may be different too much by the tolerance of the virtual reality apparatus due to the manufacturing process. Therefore, if a user wears, and uses, a virtual reality apparatus, after a period of time the user may experience a sense of dizziness.

Although conventional virtual reality apparatuses have been generally adequate for their intended purposes, they have not been entirely satisfactory in all respects. Consequently, it would be desirable to provide a solution for improving the conventional virtual reality apparatuses.

### BRIEF SUMMARY OF THE INVENTION

The present disclosure provides a head-mounted display apparatus. The tolerance due to the manufacturing process of the head-mounted display apparatus is decreased, and thus the distance between the positions of the left-eye image and the right-eye image presented to the user is reduced.

The present disclosure provides a head-mounted display apparatus including a housing, a display panel, a lens base, an adjusting ring, and a lens. The display panel is disposed in the housing. The lens base is disposed on the display panel, and includes a first guiding element. The adjusting ring is disposed on the lens base, and includes a second guiding element attached to the first guiding element. The lens is disposed on the adjusting ring. The first guiding element and the second guiding element are extended along a spiral path.

In some embodiments, the head-mounted display apparatus further includes an adhesive material disposed on the lens base and the adjusting ring, and configured to fix a relative position between the lens base and the adjusting ring.

In some embodiments, the first guiding element is a protrusion, the second guiding element comprises a through hole, the protrusion is located in the through hole, the protrusion and the through hole are an elongated structure, and the length of the through hole is more than 1.2 times longer than the length of the protrusion.

In some embodiments, the adjusting ring further includes a first ring element disposed on the lens base; and a second ring element disposed on edges of the first ring element and the lens. The second guiding element is disposed on the first ring element, and the lens is located between the first ring element and the second ring element.

In some embodiments, the lens includes a curved surface, a ring side surface, and an engaging groove formed on the curved surface and the ring side surface. The curved surface is exposed from the adjusting ring, and the adjusting ring is located in the engaging groove.

In some embodiments, a central axis passes through a central area of the lens. The display panel, the lens base, the adjusting ring, and the lens are extended perpendicular to the central axis, and arranged on the central axis in sequence.

In some embodiments, the lens base further includes a holding portion and a support portion. The holding portion disposed on the display panel, and includes a communication hole facing the display panel. The support portion is disposed on the holding portion, and includes a light channel connected to the communication hole. The first guiding element is disposed on the support portion, and the lens faces the light channel. In some embodiments, the holding portion is a plate structure, and the support portion is a truncated conical structure.

The present disclosure provides an adjusting method of the head-mounted display apparatus including providing an image on a display panel, wherein a lens base is disposed on the display panel, an adjusting ring is disposed on the lens base, and a lens is disposed on the adjusting ring; obtaining the detecting image that corresponds to the virtual image of the image via the lens by an optical instrument; analyzing the detecting image with a processing apparatus to obtain the position parameter of the virtual image; and using an adjusting apparatus to adjust the position of the adjusting ring according to the position parameter.

In some embodiments, the adjusting method of the head-mounted display apparatus, further includes coating an adhesive material to the lens base and the adjusting ring, so as to fix a relative position between the lens base and the adjusting ring.

In conclusion, by adjusting the adjusting ring of the head-mounted display apparatus of the present disclosure, the virtual images watched via the lenses by the left eye and the right eye of the user are located at the same or sustainably the same position. Therefore, the sense of dizziness that can occur after extended use of the head-mounted display apparatus is reduced.

### BRIEF DESCRIPTION OF THE DRAWINGS

The invention can be more fully understood by reading the subsequent detailed description and examples with references made to the accompanying drawings, wherein:

FIG. 1 is a perspective view of the head-mounted display apparatus 1 in accordance with some embodiments of the disclosure.

FIG. 2 is an exploded view of the head-mounted display apparatus 1 in accordance with some embodiments of the disclosure.

FIG. 3 is a cross-sectional view of the head-mounted display apparatus 1 in accordance with some embodiments of the disclosure.

FIG. 4 is a side view of the lens base 30 and the adjusting ring 40 in accordance with some embodiments of the disclosure.

FIG. 5 is a flow chart of the head-mounted display apparatus 1 in accordance with some embodiments of the disclosure.

FIG. 6 is a schematic view of the head-mounted display apparatus 1 during an intermediate stage of an adjusting method.

### DETAILED DESCRIPTION OF THE INVENTION

The following disclosure provides many different embodiments, or examples, for implementing different features of the present disclosure. Specific examples of components and arrangements are described below to simplify the present disclosure. For example, the formation of a first feature over or on a second feature in the description that follows may include embodiments in which the first and second features are formed in direct contact, and may also include embodiments in which additional features may be formed between the first and second features, such that the first and second features may not be in direct contact.

The words, such as “first” or “second”, in the specification are for the purpose of clarity of description only, and are not relative to the claims or meant to limit the scope of the claims. In addition, terms such as “first feature” and “second feature” do not indicate the same or different features.

Spatially relative terms, such as upper and lower, may be used herein for ease of description to describe one element or feature's relationship to another element(s) or feature(s) as illustrated in the figures. The spatially relative terms are intended to encompass different orientations of the device in use or operation in addition to the orientation depicted in the figures. The shape, size, thickness, and angle of tilt in the drawings may not be drawn to scale or simplified for clarity of discussion; rather, these drawings are merely intended for illustration.

It should be understood that additional operations can be provided before, during, and after the method, and some of the operations described can be replaced or eliminated for other embodiments of the method.

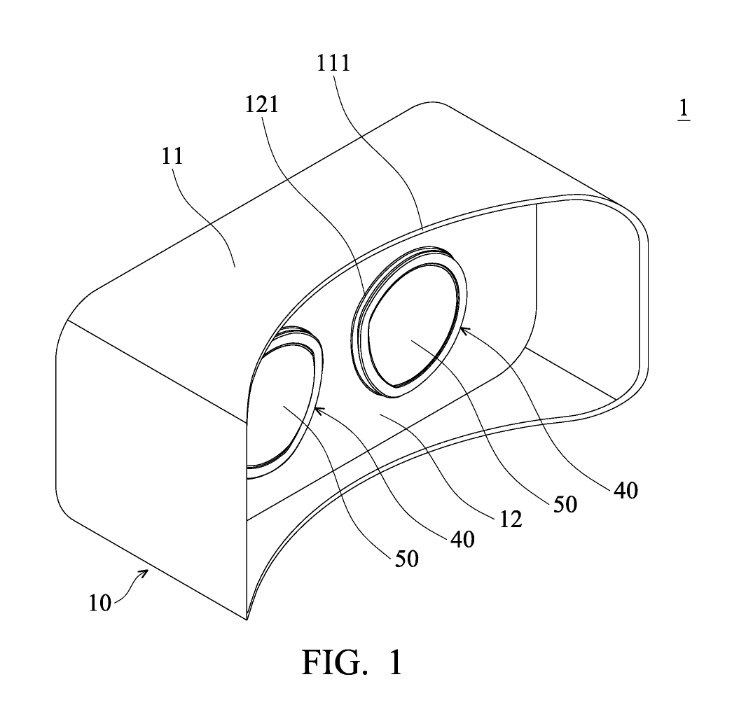

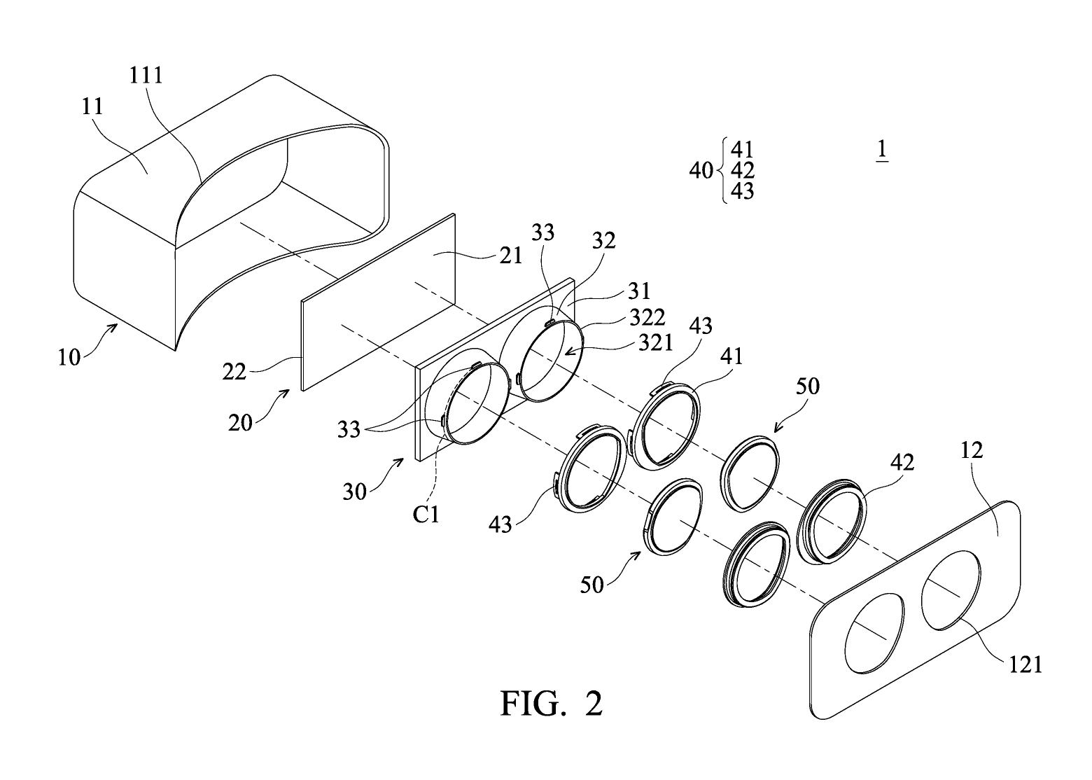

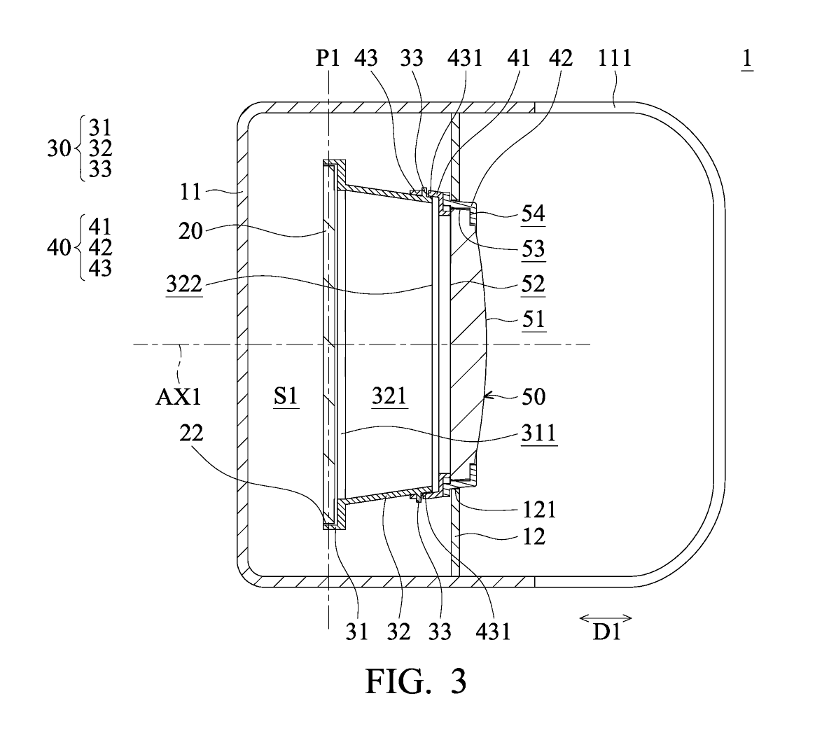

FIG. 1 is a perspective view of the head-mounted display apparatus 1 in accordance with some embodiments of the disclosure. FIG. 2 is an exploded view of the head-mounted display apparatus 1 in accordance with some embodiments of the disclosure. FIG. 3 is a cross-sectional view of the head-mounted display apparatus 1 in accordance with some embodiments of the disclosure. The head-mounted display apparatus 1 is configured to be worn on the head of the user, and provides 2D (two dimensional) images or 3D (three dimensional) images. In some embodiments, the head-mounted display apparatus 1 may be a head-mounted virtual reality apparatus.

The head-mounted display apparatus 1 includes a housing 10, a display panel 20, a lens base 30, an adjusting ring 40, and a lens 50.

The housing 10 is a shell structure. In this embodiment, the housing 10 includes a body 11 and a cover plate 12. The body 11 has a curved edge 111, and the shape of the body 11 corresponds to the user's face. The cover plate 12 is disposed in the body 11, and a receiving space S1 is formed between the cover plate 12 and the body 11. The cover plate 12 has two outer openings 121 that communicate with the receiving space S1.

The display panel 20 is disposed in the receiving space S1 within the housing 10, and configured to display an image. The image is displayed on a display surface 21 of the display panel 20. In some embodiments, the image includes a left-eye image and a right-eye image that is different from the left-eye image. In some embodiments, there are two display panels 20. The display panels 20 can display the same image. Alternately, one of the display panels 20 displays the left-eye image, and the other display panel 20 displays the right-eye image.

The display panel 20 may be extended along a reference plane P1, and it may be parallel to or substantially parallel to the cover plate 12. The display panel 20 is separated from the cover plate 12, and is retained on the lens base 30. In some embodiments, the display panel 20 is a liquid-crystal display panel (LCD panel) or an organic light-emitting diode panel (OLED panel).

The lens base 30 is located in the receiving space S1, and is configured to receive the display panel 20. The lens base 30 includes a holding portion 31, two support portions 32, and a number of first guiding elements 33.

The holding portion 31 is disposed on the display panel 20, and may be a plate structure. In this embodiment, the holding portion 31 is connected to the display panel 20, and is parallel or substantially parallel to the reference plane P1. The holding portion 31 covers the display surface 21 and the side surface 22 of the display panel 20. In some embodiments, the holding portion 31 covers a portion of the display surface 21 and all the side surface 22 of the display panel 20. In other words, the display panel 20 is retained in the holding portion 31.

The holding portion 31 includes two communication holes 311 facing the display panel 20. In a better embodiment, the area of the communication holes 311 is greater than 0.7 times the area of the display surface 21 of the display panel 20.

The support portion 32 is disposed on the holding portion 31. In this embodiment, the support portion 32 is affixed to the holding portion 31. In some embodiments, the support portion 32 and the holding portion 31 are formed as a single piece. In this embodiment, the support portion 32 is a truncated conical structure that becomes gradually narrower from the holding portion 31 to the lens 50.

The support portion 32 includes a light channel 321 and a front opening 322. The light channel 321 is connected to the communication hole 311 and the front opening 322. The front opening 322 is parallel or substantially parallel to the reference plane P1.

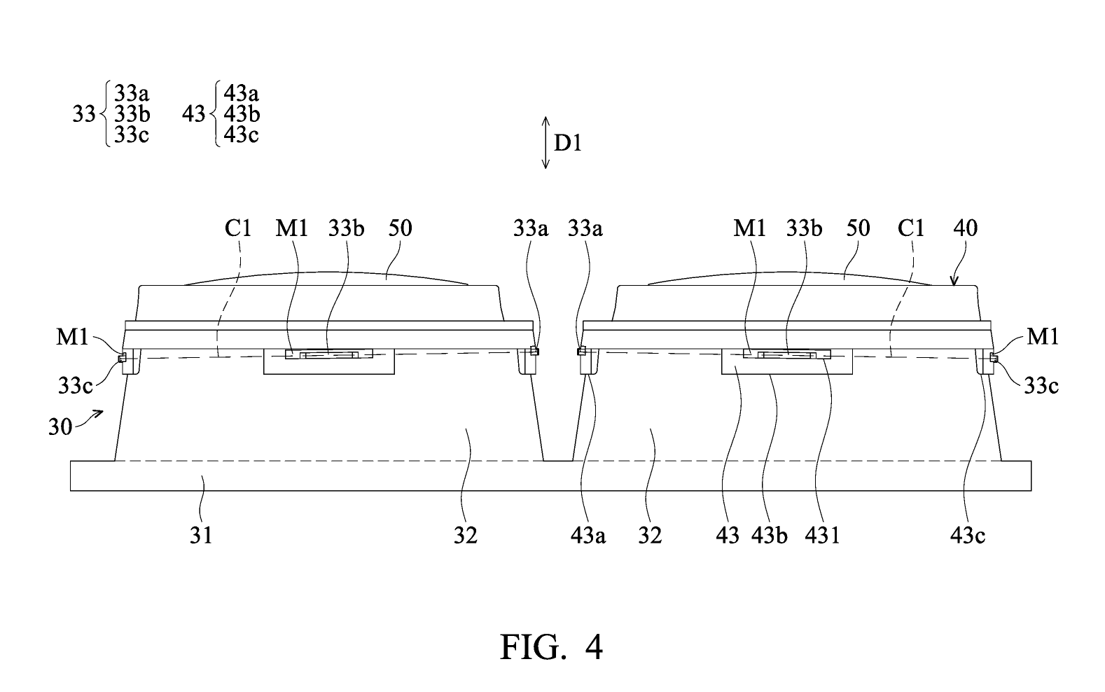

FIG. 4 is a side view of the lens base 30 and the adjusting ring 40 in accordance with some embodiments of the disclosure. The first guiding element 33 is disposed on the outer side wall of the support portion 32, and close to the front opening 322. The first guiding element 33 is an elongated structure. In this embodiment, each of the first guiding elements 33 is extended along the same spiral path C1, and they are arranged separately along the spiral path C1. The spiral path C1 is extended along the outer side wall of the support portion 32, and gradually approaches the front opening 322.

As shown in FIG. 4, the distance between the first guiding element 33a and the holding portion 31 is greater than the distance between the first guiding element 33b and the holding portion 31. The distance between the first guiding element 33b and the holding portion 31 is greater than the distance between the first guiding element 33c and the holding portion 31. Moreover, the distance between the first guiding element 33a and the front opening 322 is shorter than the distance between the first guiding element 33b and the front opening 322. The distance between the first guiding element 33b and the front opening 322 is shorter than the distance between the first guiding element 33c and the front opening 322.

In some embodiments, each of the first guiding elements 33 is extended along a different spiral path, and they are arranged separately. Each of the first guiding elements 33 is located on a plane parallel to the reference plane P1. In other words, the distances between the first guiding elements 33a, 33b, and 33c and the holding portion 31 are the same. The distances between the first guiding elements 33a, 33b and 33c and the front opening 322 are the same.

The adjusting ring 40 is disposed on the lens base 30. The adjusting ring 40 includes a first ring element 41, a second ring element 42, and second guiding elements 43. The first ring element 41 is disposed on the lens base 30, and is parallel or substantially parallel to the reference plane P1. In this embodiment, the first ring element 41 is in direct contact with the edges of the outer side wall of the support portion 32 and the lens 50, and covers the edge of the front opening 322.

The second ring element 42 is disposed on the edges of the first ring element 41 and the lens 50. The second ring element 42 is in direct contact with the first ring element 41 and the lens 50, and is parallel or substantially parallel to the reference plane P1. In some embodiments, the first ring element 41 and the second ring element 42 are formed as a single piece.

The second guiding element 43 is disposed on the first ring element 41, and is attached to the first guiding element 33. In other words, the second guiding element 43 corresponds to the position of the first guiding element 41. In this embodiment, the second guiding element 43 and the first ring element 41 are formed as a single piece. The second guiding element 43 is in direct contact with the outer side wall of the support portion 32, and is close to the front opening 322. The second guiding element 43 may be an elongated structure. In this embodiment, each of the second guiding elements 43 extends along the same spiral path C1, and they are arranged separately along the spiral path C1.

Accordingly, as shown in FIG. 4, the distance between the second guiding element 43a and the holding portion 31 is greater than the distance between the second guiding element 43b and the holding portion 31. The distance between the second guiding element 43b and the holding portion 31 is greater than the distance between the second guiding element 43c and the holding portion 31. Moreover, the distance between the second guiding element 43a and the front opening 322 is shorter than the distance between the second guiding element 43b and the front opening 322. The distance between the second guiding element 43b and the front opening 322 is shorter than the distance between the second guiding element 43c and the front opening 322.

In some embodiments, each of the second guiding elements 43 extends along a different spiral path, and the second guiding elements 43 are separated from each other. Each of the second guiding elements 43 is located at a plane parallel to the reference plane P1. In other words, the distances between the second guiding elements 43a, 43b and 43c and the holding portion 31 are the same. The distances between the second guiding elements 43a, 43b and 43c and the front opening 322 are the same.

In this embodiment, the first guiding element 33 is a protrusion. The second guiding element 43 includes a through hole 431, and the protrusion is located in the through hole 431, the protrusion and the through hole 431 are an elongated structure. In a particular embodiment, the length of the through hole 431 is more than 1.2 times longer than the length of the protrusion.

Accordingly, when the adjusting ring 40 is rotated relative to the lens base 30, the first guiding element 33 is moved relative to the second guiding element 43 by the structures of the lens base 30 and the adjusting ring 40, so as to the adjusting ring 40 and the lens 50 are moved along an adjusting direction D1. The adjusting direction D1 is perpendicular to or substantially perpendicular to the reference plane P1.

Moreover, the movement of the first guiding element 33 is limited in the through hole 431, so as to the rotation angle of the adjusting ring 40 relative to the lens base 30 is limited, and the distance of the adjusting ring 40 moved along adjusting direction D1 relative to the lens 50 is limited.

The lens 50 is disposed on the adjusting ring 40, and is parallel or substantially parallel to the reference plane P1. In this embodiment, the lens 50 is located between the first ring element 41 and the second ring element 42, and located at or adjacent to the outer opening 121 of the cover plate 12.

In this embodiment, the lens 50 is a convex lens. The lens 50 includes a curved surface 51, a rear surface 52, a ring side surface 53, and an engaging groove 54. The curved surface 51 is exposed from the adjusting ring 40. The rear surface 52 is opposite to the curved surface 51, and faces the display panel 20 and light channel 321. In this embodiment, the rear surface 52 is a flat plane. The ring side surface 53 is connected to the rear surface 52 and the engaging groove 54.

The engaging groove 54 is located at the edge of the lens 50, and formed on the curved surface 51 and the ring side surface 53. The second ring element 42 of the adjusting ring 40 is located in the engaging groove 54. Therefore, by the structure of the adjusting ring 40, the lens 50 can be stably fixed in the adjusting ring 40.

In this embodiment, a central axis AX1 passes through the central area of the lens 50. The central axis AX1 is parallel to the adjusting direction D1, and it is perpendicular to or substantially perpendicular to the reference plane P1. The display panel 20, the lens base 30, the adjusting ring 40, and the lens 50 are arranged perpendicular to or substantially perpendicular to the central axis AX1 in sequence. In some embodiments, the central axis AX1 passes through the central area of the adjusting ring 40 and the lens base 30.

As shown in FIG. 4, the head-mounted display apparatus 1 further includes an adhesive material M1. The adhesive material M1 is disposed on the lens base 30 and the adjusting ring 40, and is configured to fix the relative position between the lens base 30 and the adjusting ring 40.

When the user wears the head-mounted display apparatus 1, the images generated by the display panel 20 enters into the user's eyes via the lens base 30 and the lenses 50. After the image is refracted by the lenses 50, enlarged virtual images corresponding to the images are viewed via the lens 50 by the left eye and the right eye. Since the enlarged virtual images occupy most of the view of the user, the head-mounted display apparatus 1 provides a great visual effect to the user. Moreover, when the images provided to the left eye and the right eye are different, 3D images are produced.

However, a tolerance may be generated during the manufacturing process of the lens base 30 and the lens 50, wherein the position of the virtual image corresponding to the left eye may be different from the position of the virtual image corresponding to the right eye. When the above situation occurs, the user may experience a sense of dizziness during the viewing process. Therefore, in this embodiment, before the adhesive material M1 is coated, the adjusting ring 40 can be adjusted to make sure that the position of the virtual image corresponding to the left eye is the same as the position of the virtual image corresponding to the right eye. Therefore, the sense of dizziness is less pronounced when the user uses the head-mounted display apparatus 1.

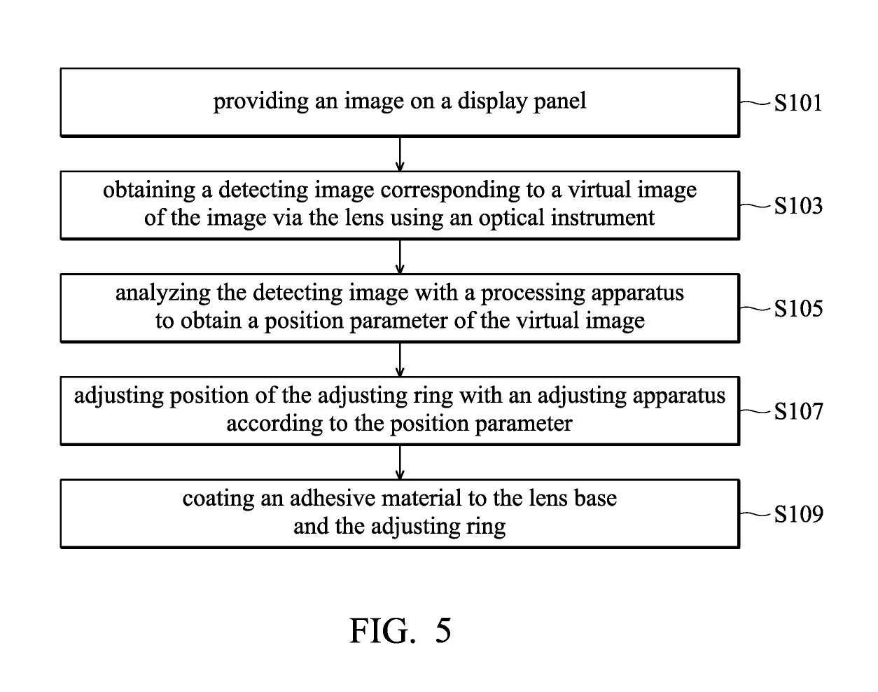

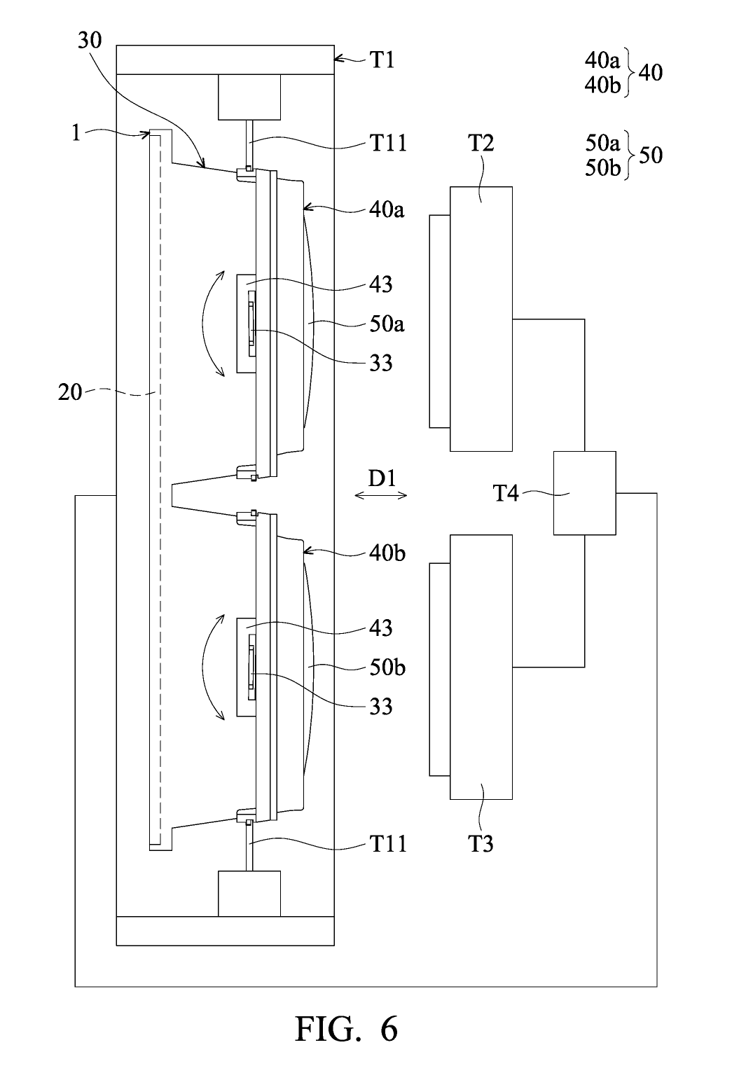

FIG. 5 is a flow chart of the head-mounted display apparatus 1 in accordance with some embodiments of the disclosure. FIG. 6 is a schematic view of the head-mounted display apparatus 1 during an intermediate stage of an adjusting method. As shown in FIG. 6, the elements of the head-mounted display apparatus 1, such as the display panel 20, the lens base 30, the adjusting ring 40 and the lens 50 are put on an adjusting apparatus T1. In other words, the elements such as the display panel 20, the lens base 30, the adjusting ring 40, and the lens 50 are not disposed in the housing 10. The adjusting mechanism T11 of the adjusting apparatus T1 is in contact with the adjusting ring 40.

The optical instruments T2 and T3 face the lens 50. In this embodiment, the optical instruments T2 and T3 are cameras. The processing apparatus T4 may be a computer, electrically connected to the adjusting apparatus T1, the optical instruments T2 and T3, and the display panel 20. In some embodiments, one optical instrument T2 is used. The optical instrument T2 alternately corresponds to lens 50a or lens 50b by moving the optical instrument T2 relative to the adjusting apparatus T1.

In step S101 of the adjusting method of the head-mounted display apparatus 1, the processing apparatus T4 controls the display panel 20 to generate an image. The image enters to the optical instruments T2 and T3 via the lenses 50a and 50b.

In step S103, the optical instrument T2 takes a photograph through the lens 50a, and obtains a first detecting image of a first virtual image corresponding to the image. Afterwards, the first detecting image is transmitted to the processing apparatus T4, and processed by the processing apparatus T4. The optical instrument T3 takes a photograph through the lens 50b, and obtains a second detecting image of a second virtual image corresponding to the image. Afterwards, the second detecting image is transmitted to the processing apparatus T4, and processed by the processing apparatus T4.

In step S105, after the processing apparatus T4 analyzes the first detecting image, a first position parameter of the first virtual image is obtained. After the processing apparatus T4 analyzes the second detecting image, a second position parameter of the second virtual image is obtained.

In step S107, the processing apparatus T4 compares the first position parameter and a predetermined position parameter, and controls the adjusting mechanism T11 to adjust the position of the adjusting ring 40a according to the results of the comparison, so as to set the position of the first virtual image to within a predetermined range. The processing apparatus T4 controls the adjusting mechanism T11 to adjust the position of the adjusting ring 40b according to the results of the comparison, so as to ensure that the position of the second virtual image is located within a predetermined range.

In another embodiment, the processing apparatus T4 compares the first position parameter with the second position parameter, and controls the adjusting mechanism T11 to adjust the position of the adjusting ring 40a according to the results of the comparison, so as to set the position of the second virtual image to within a predetermined range, and to align it with the position of the first virtual image.

After step S107 is processed, step S103 and step S105 may be processed again. The processing apparatus T4 compares the updated first position parameter and the updated second position parameter with the predetermined position parameter. If the first position parameter and the second position parameter are located within a predetermined parameter range, the adjustment of the head-mounted display apparatus 1 is complete. In another embodiment, the processing apparatus T4 compares the updated first position parameter with the updated second position parameter.

By using the adjusting method of the head-mounted display apparatus 1, the virtual images viewed through the lenses by the left eye and the right eye are located in the same (or substantially the same) position. Therefore, the sense of dizziness is reduced when the user wears and uses the head-mounted display apparatus.

Afterwards, step S109 is processed. An adhesive material M1 is coated on the lens base 30 and adjusting ring 40 to fix the relative position between the lens base 30 and the adjusting ring 40. Finally, the elements, such as the display panel 20, the lens base 30, the adjusting ring 40, and the lens 50 are disposed in the housing 10 to complete the assembly of head-mounted display apparatus 1.

In conclusion, by adjusting the adjusting ring of the head-mounted display apparatus of the present disclosure, the virtual images viewed through the lenses by the left eye and the right eye are located at the same (or substantially the same) position. Therefore, the user's sense of dizziness is reduced when the user wears and uses the head-mounted display apparatus.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A head-mounted display apparatus, comprising:
a housing;
a display panel, disposed in the housing;
a lens base, disposed on the display panel, comprising a first guiding element;
an adjusting ring, disposed on the lens base, comprising a second guiding element attached to the first guiding element; and
a lens disposed on the adjusting ring;
wherein the first guiding element and the second guiding element are extended along a spiral path.

2. The head-mounted display apparatus as claimed in claim 1, further comprising an adhesive material disposed on the lens base and the adjusting ring, and configured to fix a relative position between the lens base and the adjusting ring.

3. The head-mounted display apparatus as claimed in claim 1, wherein the first guiding element is a protrusion, the second guiding element comprises a through hole, the protrusion is located in the through hole, the protrusion and the through hole are an elongated structure, and length the through hole is more than 1.2 times longer than the length of the protrusion.

4. The head-mounted display apparatus as claimed in claim 1, wherein the adjusting ring further comprises:
a first ring element disposed on the lens base; and
a second ring element disposed on edges of the first ring element and the lens;
wherein the second guiding element is disposed on the first ring element, and the lens is located between the first ring element and the second ring element.

5. The head-mounted display apparatus as claimed in claim 1, wherein the lens comprises a curved surface, a ring side surface, and an engaging groove formed on the curved surface and the ring side surface, wherein the curved surface is exposed from the adjusting ring, and the adjusting ring is located in the engaging groove.

6. The head-mounted display apparatus as claimed in claim 1, wherein a central axis passes through a central area of the lens, and the display panel, the lens base, the adjusting ring, and the lens are extended perpendicular to the central axis, and arranged on the central axis in sequence.

7. The head-mounted display apparatus as claimed in claim 1, wherein the lens base further comprises:
a holding portion, disposed on the display panel, comprising a communication hole facing the display panel; and
a support portion, disposed on the holding portion, comprising a light channel connected to the communication hole;
wherein the first guiding element is disposed on the support portion, and the lens faces the light channel.

8. The head-mounted display apparatus as claimed in claim 7, wherein the holding portion is a plate structure, and the support portion is a truncated conical structure.

9. An adjusting method of a head-mounted display apparatus, comprising:
providing an image on a display panel, wherein a lens base is disposed on the display panel, an adjusting ring is disposed on the lens base, and a lens is disposed on the adjusting ring;
obtaining a detecting image corresponding to a virtual image of the image via the lens using an optical instrument;
analyzing the detecting image with a processing apparatus to obtain a position parameter of the virtual image; and
adjusting position of the adjusting ring with an adjusting apparatus according to the position parameter.

10. The adjusting method as claimed in claim 9, further comprising coating an adhesive material to the lens base and the adjusting ring, so as to fix a relative position between the lens base and the adjusting ring.
